(19) United States
(12) Patent Application Publication
(10) Pub. No.: US 2007/0296206 A1
(43) Pub. Date: Dec. 27, 2007

(54) RECORD CARRIER WITH VISUAL WATERMARK ON DATA AREA

(75) Inventors: Pieter Wilhelmus Theodorus DE JONG, Eindhoven (NL); Jan Harm DE BOER, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,775

(22) PCT Filed: Jun. 1, 2005
(86) PCT No.: PCT/IB05/51780

§ 371 Date: Nov. 29, 2006

(30) Foreign Application Priority Data
Jun. 7, 2004 (EP) 04102557.8

(51) Int. Cl. B42D 15/00

(52) U.S. Cl. 283/113

(57) ABSTRACT

A record carrier (1) comprising a data area (3) with a pattern of substantially parallel tracks (2) for storing data. The record carrier (1) comprises at least first and second areas, the tracks in the first areas (4) comprising a first periodic deflection and the tracks in the second areas (5) comprising a second periodic deflection. A visual contrast between the respective areas is realized by a difference between the first and the second periodic deflection. The visual contrast represents a visual watermark.

The invention relates to a record carrier comprising a data area with a pattern of substantially parallel tracks for storing data, the record carrier comprising at least first and second areas, a visual contrast between the respective areas representing a visual watermark.

The invention also relates to a method and an apparatus for applying a visual watermark to a record carrier.

A record carrier of this type is known from European Patent Application 1079381. This document discloses a record carrier provided with a visual watermark comprising pits in a form of a concave carrying information signals and lands in a form of a convex, the pits and the lands being alternately formed in rows on the recording medium. In the land between the adjacent pits recesses are formed which are less deep than the pits. A group of the recesses represents a visual pattern.

Such a record carrier has the drawback that it is quite difficult to produce large volumes of such record carriers while conforming to the specifications, which are part of international standards. As a consequence the probability of facing read out problems when retrieving data from such record carriers using standard equipment is increased. It is another drawback of such a record carrier that it is extremely difficult to apply the watermark to recordable record carriers.

It is an object of the invention to realize a record carrier on which a visual watermark is provided, with minimal negative influence on the readability of the data on the record carrier.

According to the invention, this object is achieved by providing a record carrier which is characterized in that the tracks in the first areas comprise a first periodic deflection and the tracks in the second areas comprise a second periodic deflection and the visual contrast between the respective areas is realized by a difference between the first and the second periodic deflection.

The periodic deflection forms a wave pattern which, when equally present in the tracks in a certain area, results in a visual effect. Different wave patterns in different areas result in visual contrast between the respective areas. In the record carrier according to the invention the contrast is used for providing a record carrier with a visual watermark.

It is an advantage of the record carrier according to the invention, that the periodic deflection of the tracks has little influence on the readability of the data. Even small deflections, with little effect on the readability, do result in a significant visual effect.

The inventors have seen that areas on a record carrier comprising tracks with a periodic deflection can be visually distinguished from areas without such a periodic deflection. Furthermore the inventors have seen that areas on a record carrier comprising tracks with a periodic deflection can be visually distinguished from areas comprising tracks with a different periodic deflection. The periodic deflection can be applied to the tracks within tolerances allowed in specifications which are part of international standards, thereby enabling data read out by standard equipment.

The periodic deflection may, for example, comprise a sinusoidal pattern, a saw tooth pattern or a square wave pattern.

The variations in the periodic deflection may, for example, be realized in the type, the amplitude or the frequency of the periodic deflection of the tracks. The variations in the periodic deflection may also be realized in a phase shift, exhibited by the periodic deflection of adjacent tracks.

The invention further relates to a method for applying a visual watermark to a record carrier. The method comprises the steps of: receiving information to be encoded in tracks on the record carrier, receiving lay out data, defining the visual watermark, creating a pattern of substantially parallel tracks, applying local variations to a periodic deflection of the tracks depending on the lay out data, and applying the tracks to the record carrier.

It is an advantage of the method according to the invention that it can easily be applied to recordable record carriers. Many recordable record carriers, like recordable CD's and recordable DVD's, comprise a shallow periodic pregroove along which data can be applied by means of modulation of the pregroove. According to the invention, an additional modulation of a global parameter of the periodic pregroove in certain areas of the data area of the recordable record carrier, results in differences between the visual appearances of the various areas.

The invention also relates to a device for applying a visual watermark to a record carrier. The device comprises an input for receiving information to be encoded in tracks on the record carrier and lay out data, defining the visual watermark, a formatter for determining a pattern of substantially parallel tracks and for applying local variations to a periodic deflection of the tracks depending on the lay out data, and means for applying the tracks to the record carrier.

These and other aspects of the invention are apparent from and will be elucidated with reference to the embodiments described hereinafter.

### BRIEF DESCRIPTION OF THE DRAWINGS

In the drawings:

FIG. 1 shows a record carrier according to the invention,

FIG. 2A shows two exemplary tracks, formed by a sequence of marks,

FIG. 2B-2C show exemplary tracks, formed by a sequence of marks, the tracks comprising a periodic deflection,

FIG. 3A-3D show exemplary tracks, formed by a pregroove, comprising a periodic deflection,

FIG. 4A-4C show exemplary arrangements of a plurality of tracks comprising a periodic deflection,

FIG. 5 shows a flowchart of the method according to the invention, and

FIG. 6 shows a schematic representation of the device according to the invention.

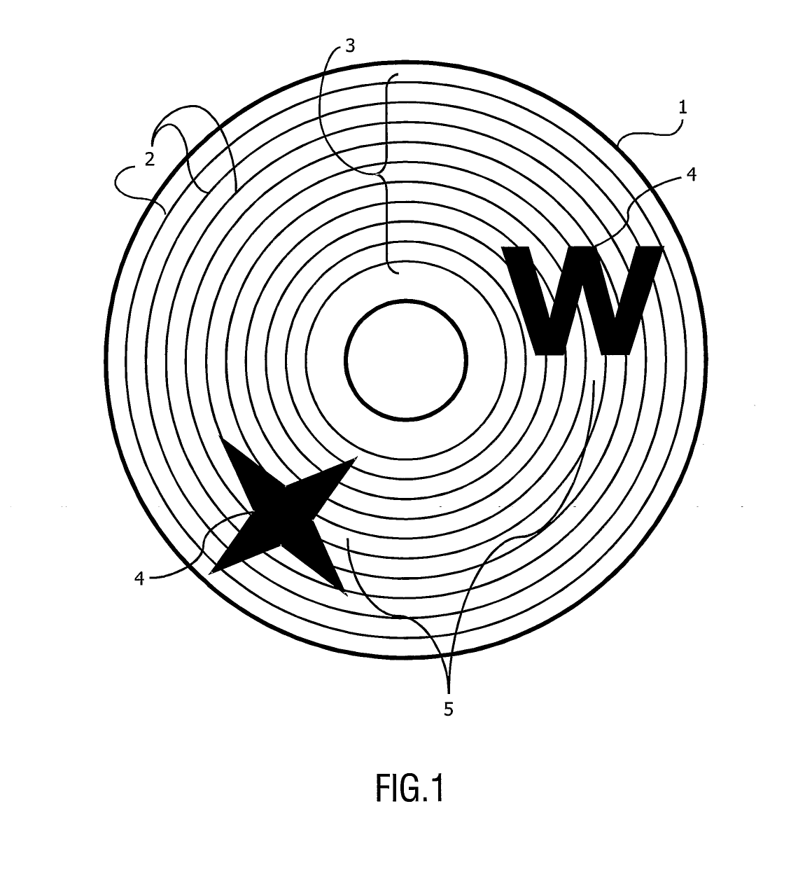

FIG. 1 shows a record carrier 1 according to the invention. The record carrier shown in FIG. 1 is a circular shaped record carrier, such as a CD, DVD or BD, but also rectangular record carriers or record carriers with any other shape may be used. The record carrier 1 comprises a pattern of substantially parallel concentric tracks 2 for storing data on a data area 3. The tracks 2 preferably emerge from a single continuous spiral. Data is stored in the form of marks, in which the data is encoded. The tracks 2 may be formed by a sequence of said marks, like in read only CD's, DVD's or BD's. In recordable record carriers, not yet comprising any data, the tracks 2 may be formed by a so called pregroove. The pregroove is used for providing timing and addressing information to devices for writing data onto recordable record carriers. Usually, the pregroove on recordable record carriers comprises a modulated periodic deflection for providing this information. The writing devices use the timing and addressing information for determining where on the data area 3 to apply the marks for coding the data.

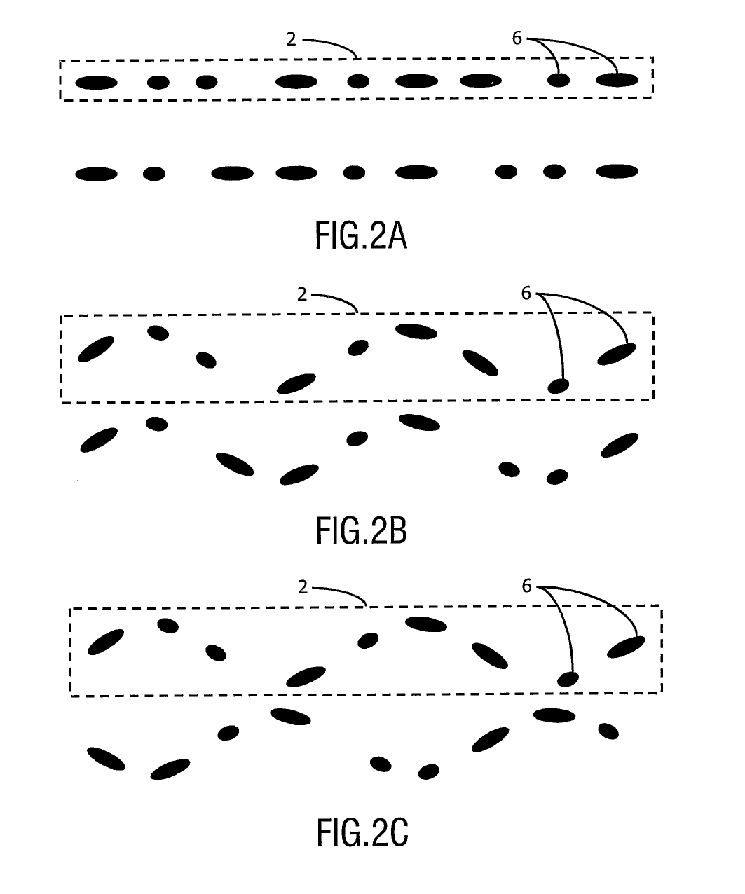

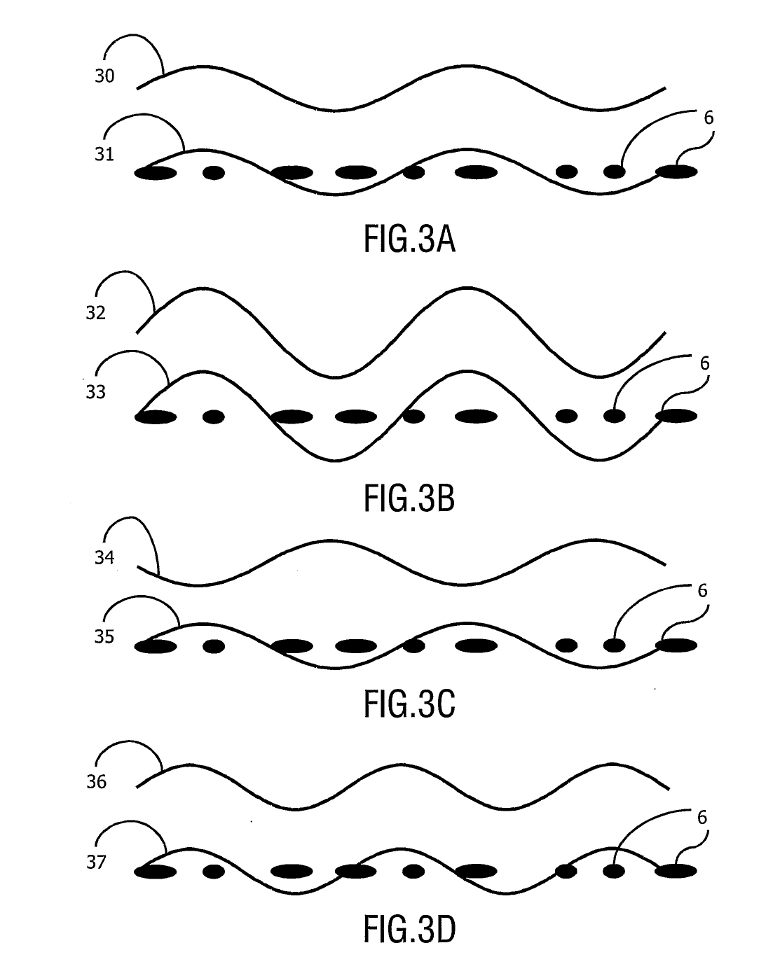

According to the invention, in specific areas 4, 5 of the data area 3 a periodic deflection is applied to the tracks 2 for constituting a visual watermark. The periodic deflection may, for example, comprise a sinusoidal, saw tooth or square wave pattern. Areas with tracks comprising different types of periodic deflections can be visually distinguished from each other. Areas with tracks 2 comprising a periodic deflection can visually be distinguished from areas with tracks 2 without a periodic deflection. Furthermore, amplitude, frequency and phase of the periodic deflection of the tracks 2 influence the visual appearance of the respective areas and can be modulated for providing a visual watermark to the data area 3 of the record carrier. The modulations of the periodic deflection of adjacent tracks are correlated for constituting the respective areas. The visual watermark may show characters, logos or complete texts or pictures. The visual watermark may comprise information or may just serve decorative purposes. Hereinafter, referring to FIGS. 2 and 3, some examples of tracks comprising a periodic deflection are described in detail.

FIG. 2A shows two exemplary tracks, formed by a sequence of marks. Both tracks 2 are substantially parallel and do not comprise a periodic deflection. Usually, for read only CD, DVD and BD, the tracks are arranged as shown in FIG. 2A and do not comprise a periodic deflection. FIGS. 2B and 2C show exemplary tracks 2, formed by a sequence of marks 6, comprising a periodic deflection. If such a periodic deflection is applied to the tracks 2 at some specific areas 3 of the record carrier 1, these areas 3 can be visually distinguished from areas without such a periodic deflection. In the Figures the deflection of the tracks 2 is exaggerated. In reality a visual effect can be observed with a deflection which is just a small fraction, e.g. 2%, of the track pitch (1.6 μm for standard CD). In general, larger deflections, e.g. 10% of the track pitch, will result in a more distinct visual effect, but will also result in a greater probability of facing read out problems. In FIG. 2B the periodic deflections of the two adjacent tracks 2 are in phase. In FIG. 2C the periodic deflections of the two adjacent tracks 2 are in anti phase. Areas wherein adjacent tracks are in phase can visually be distinguished from areas wherein adjacent tracks are in anti phase. Tracks that are in anti phase exhibit a phase shift of 180°. Other phase shifts may be applied to adjacent tracks or no specific phase shift may be applied at all. In concentric circular tracks, the exact phase shift between the periodic deflections of two adjacent tracks depends on the frequency of the periodic deflection and on the length of the tracks. For the periodic deflection of two adjacent tracks to be in phase or to show a constant phase shift, the spatial frequency of the deflection of the outer track has to be lower than the frequency of the deflection of the inner track because the outer track is longer than the inner track.

FIG. 3A-3D show exemplary tracks, formed by a pregroove 30-37, comprising a periodic deflection. Such a pregroove is often applied to recordable record carriers for providing timing and addressing information. The pregroove with the periodic deflection is often called a ‘wobble’ or a ‘wobbled pregroove’. When writing data onto a recordable record carrier, the marks 6 representing the data are applied to the data area along the pregroove. In the FIGS. 3A-3D data is written onto the lower track 31, 33, 35, 37 of the two tracks shown and the upper track 30, 32, 34, 36 is unrecorded. All four FIGS. 3A-3D show arrangements of pregrooves and marks as can be found as such in known recordable record carriers. However according to the invention different areas of one recordable record carrier comprise different arrangements of pregrooves, these areas can be visually distinguished from each other. The FIGS. 3B-3D show variations in the periodic deflection, which may be applied to the tracks in specific areas on the data area of the recordable record carrier for constituting a visual watermark. The changes shown in FIG. 3B-3D relative to the periodic deflection shown in FIG. 3A are:

FIG. 3B: larger amplitude of the periodic deflection,

FIG. 3C: 180° phase shift exhibited by the periodic deflection of adjacent tracks, and

FIG. 3D: higher frequency of the periodic deflection.

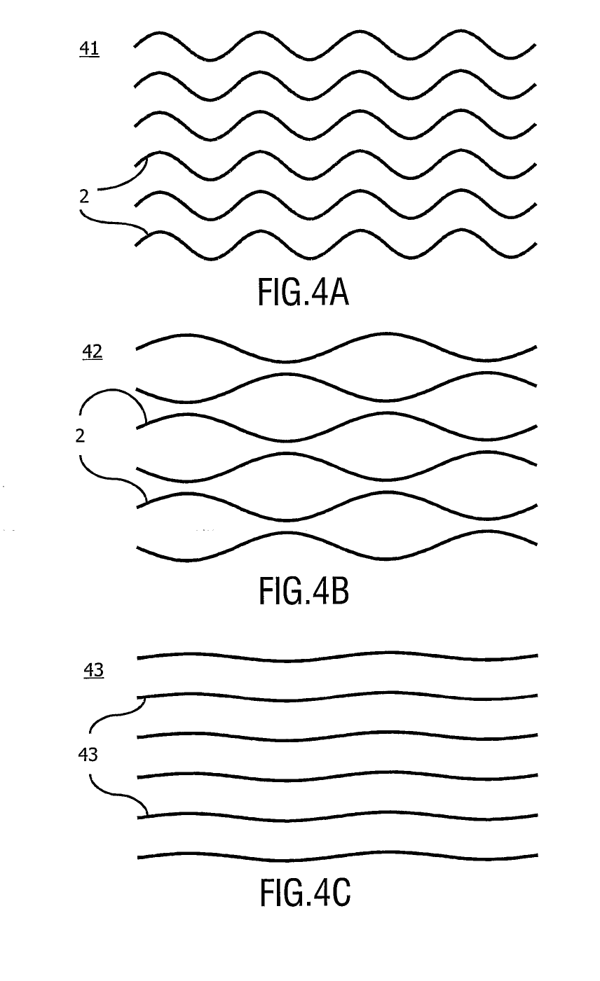

FIG. 4A-4C show exemplary arrangements 41, 42, 43 of a plurality of tracks 2 comprising a periodic deflection. The tracks 2 may, for example, be formed by sequences of marks in read only record carriers or pregrooves in recordable record carriers. Relative to the tracks 2 in the pattern 41 of FIG. 4A, the tracks 2 in the pattern 42 of FIG. 4B have a periodic deflection with a lower frequency and a phase shift of 180° between the periodic deflection of adjacent tracks 2. Relative to the tracks 2 in the pattern 41 of FIG. 4A, the tracks 2 in the pattern 43 of FIG. 4C have a lower frequency and a lower amplitude.

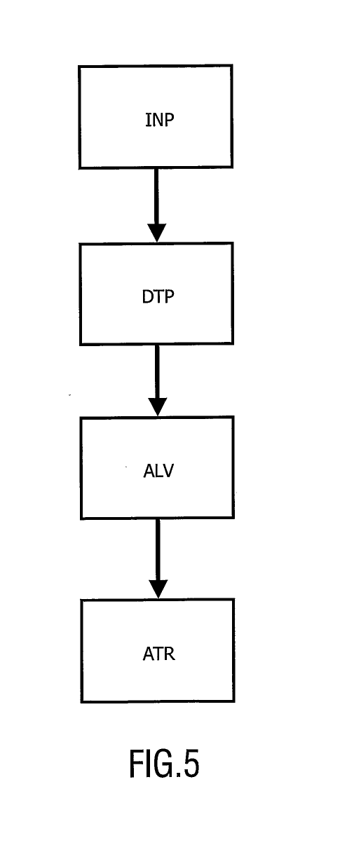

FIG. 5 shows a flowchart of a method for providing a record carrier with a visual watermark. It is to be noted that in general, read only optical record carriers like CD's, DVD's or BD's are pressed from master record carriers. Because such a master record carrier comprises all data that has to be stored on the read only optical record carrier, the master record carrier itself is considered to be a record carrier too. Using a master record carrier enables mass production of copies of read only record carriers, because pressing a record carrier from a master record carrier takes far less time than, for example, using a laser beam for writing data onto each individual copy of the record carrier. Recordable record carriers are also pressed from master record carriers. For recordable record carriers, master record carriers are produced comprising the geometry of the pregroove of the recordable record carrier. The method according to the invention may, may for example be performed by a device for producing master record carriers, a device for writing data onto recordable record carriers or combinations of such devices with a computer, a computer network or a computer program. A device for writing data onto recordable record carriers may provide a recordable record carrier, which already comprises a periodic pregroove, with a sequence of marks, where a periodic deflection is applied to the sequence of marks for constituting the watermark.

In a first step INP information to be encoded in tracks and lay out data is received. The information comprises all information that is to be stored on the record carrier, e.g., a video title, an audio title or a computer game. For recordable record carriers the information may comprise timing and addressing information to be encoded in a pregroove. The lay out data defines the visual watermark. Then the information is encoded and a pattern of substantially parallel tracks is created in the next step DTP. Then the lay out data is analyzed and local variations are applied to a periodic deflection of the tracks in a next step ALV. In this step, according to the lay out of the visual watermark, variations are applied to the periodic deflection of the tracks in specific areas of the record carrier. It is to be noted that one of the possible variations may be that the tracks in a specific area do not comprise a periodic deflection at all (amplitude is zero). Then when the complete track pattern with the variations in the periodic deflection of the tracks is determined, in a final step ATR the track pattern is physically applied to the record carrier and a record carrier comprising a visual watermark in the data area is produced. Alternatively the pattern of periodic deflections is determined before applying the tracks to the record carrier and the information is encoded ‘real time’, during the applying of the tracks.

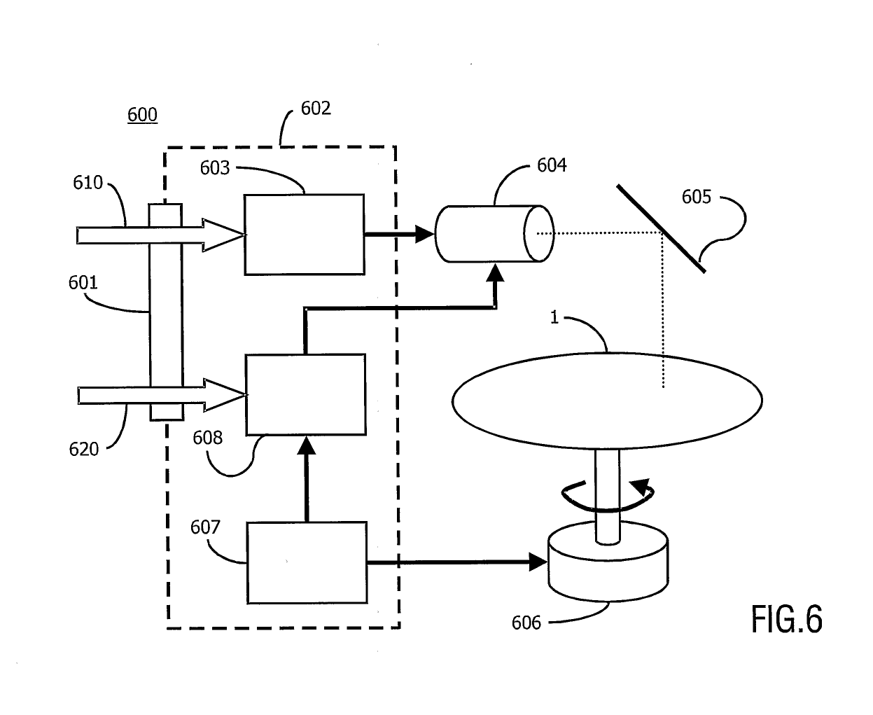

FIG. 6 shows a schematic representation of a device 600 for providing a record carrier 1 with a visual watermark. As explained above, the record carrier 1 may, for example, be a read only record carrier, recordable record carrier or a master record carrier. The device 600 comprises an input 601 for receiving information 610 to be encoded in tracks on the record carrier and lay out data 620. The information 610 may, for example, be content data or timing and addressing information. The lay out data defines the visual watermark. A formatter 602 analyzes the input data and controls writing of the tracks 2 onto the record carrier 1. The formatter comprises a writing unit driver 603 a radial position controller 608 and a rotation speed controller 607. The writing unit driver 603 converts the information to be encoded 610 to a control signal for controlling writing unit 604 for writing the data onto the record carrier 1. The writing unit 604 may, for example, be a laser beam producing unit. When the writing unit driver 603 sends a high intensity signal to the laser beam producing unit, a laser beam is sent through an optical path, possibly comprising mirrors 605 or lenses (not shown). When the laser beam reaches the data area of the record carrier 1, a pit is recorded. When the writing unit driver 603 sends a low intensity signal to the laser beam producing unit, no pit is recorded. When applying a pregroove to a recordable record carrier, a constant intensity signal is sent to the writing unit 604. The radial position controller 608 and the rotation speed controller 607, in cooperation control the position of the laser beam relative to the record carrier 1 for enabling writing data onto substantially parallel tracks on the data area of the record carrier 1.

Each position on a disc shaped record carrier can be defined by a radius (r) and an angle (φ). The radial position controller 608 controls the radius on the record carrier 1 at which the laser beam writes the pits. The radial position may, for example, be controlled by moving the writing unit 604, changing the optical path by moving or tilting the mirrors 605 or by moving the record carrier 1. The rotation speed controller 607 controls the rotation of a spindle motor 606 for rotating the record carrier 1 and enables applying pits at all angles. In the device 600 according to the invention, the formatter 602 receives the lay out data 620 of the label and determines in which areas on the record carrier 1 the tracks should comprise a periodic deflection. For the tracks that should comprise a periodic deflection, the formatter 602 also determines the type, amplitude, frequency and phase of the periodic deflection. During applying the data to the tracks the radial position controller 608 controls the periodic deflection of the writing unit 604 for applying the visual watermark to the record carrier 1. Preferably, during writing of the tracks, the writing unit 604 gradually moves from the inner track to the outer track for applying the encoded information to the data area and a deflection mirror is used for applying the periodic deflection to the tracks.

For controlling the phase or the frequency of the periodic deflection, the periodic deflection has to be correlated with the rotation speed. The frequency of the periodic deflection depends on the rotation speed of the record carrier 1 and the time needed for changing from minimal to maximal deflection. For realizing a constant phase shift between the periodic deflections of adjacent tracks, the periodic deflection has to be applied at constant angular velocity (CAV). If the content data is also applied at constant angular velocity, the record carrier may be rotated at a constant angular velocity and the radial position controller 608 may apply the periodic deflection at a constant frequency. If the content data is applied at constant linear velocity (CLV), the record carrier rotates slower when writing data at the outer tracks of the record carrier, and faster when writing data at the inner tracks. In that case, the frequency of the periodic deflection has to be adjusted to the rotation speed for realizing a constant phase shift between the periodic deflection of adjacent tracks. Therefore, during recording of the content data and the watermark, the rotation speed is communicated to the radial position controller 608 for enabling accurate control of the deflection.

In devices for writing data onto non concentric data tracks the position controller unit preferably works in two dimensions for enabling writing data onto the substantially parallel tracks on the data area and applying the periodic deflection to the tracks.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A record carrier (1) comprising a data area (3) with a pattern of substantially parallel tracks (2) for storing data, the record carrier (1) comprising at least first and second areas, the tracks in the first areas (4) comprising a first periodic deflection and the tracks in the second areas (5) comprising a second periodic deflection, a visual contrast between the respective areas being realized by a difference between the first and the second periodic deflection, the visual contrast representing a visual watermark.

2. A record carrier (1) as claimed in claim 1, said difference in the periodic deflection being realized in an amplitude of the periodic deflection.

3. A record carrier (1) as claimed in claim 1, said difference in the periodic deflection being realized as variations in the frequency of the periodic deflection.

4. A record carrier (1) as claimed in claim 1, said difference in the periodic deflection being realized as a phase shift exhibited by the periodic deflection of adjacent tracks.

5. A record carrier (1) as claimed in claim 1, wherein the periodic deflection comprises a sinusoidal pattern.

6. A record carrier (1) as claimed in claim 1, wherein the periodic deflection comprises a square wave pattern.

7. A method for providing a record carrier (1) with a visual watermark (4) in a data area (3) of the record carrier (1), the method comprising:
receiving information to be encoded in tracks on the record carrier (INP),
receiving lay out data, defining the visual watermark (INP),
creating a pattern of substantially parallel tracks (DTP),
applying differences between a periodic deflection of the tracks (2) in a first area (4) and in a second area (5) depending on the lay out data (ALV), and
applying the tracks to the record carrier (ATR).

8. A device (600) for providing a record carrier (1) with a visual watermark in a data area (3) of the record carrier (1), the device (600) comprising:
an input (601) for receiving information to be encoded in tracks on the record carrier (610) and lay out data (620), defining the visual watermark (4),
a formatter (602) for determining a pattern of substantially parallel tracks (2) and for applying differences between a periodic deflection of the tracks (2) in a first area (4) and in a second area (5) depending on the lay out data (620), and
means (604-608) for applying the tracks to the record carrier.
